(19) United States
(12) Patent Application Publication
(10) Pub. No.: US 2019/0173372 A1
(43) Pub. Date: Jun. 6, 2019

(54) SWITCHING POWER SUPPLY CIRCUIT STRUCTURE

(71) Applicant: Chicony Power Technology Co., Ltd., New Taipei City (TW)

(72) Inventor: Chen-Chi LIN, New Taipei City (TW)

(21) Appl. No.: 15/900,050

(22) Filed: Feb. 20, 2018

(30) Foreign Application Priority Data
Dec. 6, 2017 (TW) 106142806

(51) Int. Cl. H02M 1/14; H02M 3/155; H02M 1/08

(52) U.S. Cl. CPC H02M 1/143; H02M 1/08; H02M 3/155

(57) ABSTRACT

A switching power supply circuit structure is disclosed. The switching power supply circuit structure includes an input terminal, an output terminal, an energy storage capacitor, a boost circuit, and a second inductor. The input terminal is connected in parallel with an input capacitor. The output terminal has a positive terminal and a negative terminal. The energy storage capacitor is electrically connected between the positive terminal and the ground terminal. The boost circuit comprises a first inductor, a switch component and a diode. One end of the first inductor, the switch component and the diode are electrically connected to each other to form a common point. The switch component is electrically connected between the common point and the ground terminal. The second inductor is electrically connected between the negative terminal and the common point, wherein the negative terminal is not connected to the ground terminal.

### BACKGROUND OF THE INVENTION

### 1. Field of the Invention

The present invention relates to a switching power supply circuit structure, particularly to a switching power supply circuit structure capable of reducing the inductor magnetizing current and output ripple effectively.

### 2. Description of the Related Art

Nowadays, two kinds of power supplies, the linear power supply and the switching power supply, have been developed. The linear power supply features a simple structure, low cost, less damage and less output noise, but it is easily affected by the input voltage. Also, its volume increases with the output voltage or current, and the energy conversion efficiency is not greater than that of the switching power supply. Conversely, the switching power supply has a complex structure, high cost, and more output power noise, but it is smaller than the linear power supply at the same output power, and the conversion efficiency is relatively high.

There are three types of switching power supplies in the prior art: buck converters, boost converters, and buck-boost converters. Among them, the input current of boost converters will not be interrupted and has a good power factor correction in the AC/DC conversion application, and the inductor magnetizing current is relatively small. However, when the field effect transistor is turn on, the inductors are not connected in series or in parallel with the output terminal, resulting in a larger output ripple. The boost converter can only be applied to occasions where the output voltage is higher than the input voltage. The inductor of the buck converter is always connected in series or in parallel with the output terminal, and it has a smaller output ripple. However, the input current will be interrupted, resulting in a large magnetizing current of the inductor, which can only be applied to occasions where the output voltage is lower than the input voltage. In addition, the buck-boost converter can be applied to occasions where the output voltage is lower or higher than the input voltage. The input current will be interrupted, resulting in a larger magnetizing current of the inductor. Also, when the field effect transistor is turn on, the inductor is not connected in series or in parallel with the output, resulting in a larger output ripple, which is its shortcoming.

Accordingly, it is necessary to devise a new switching power supply circuit structure to solve the problem in the prior art.

### SUMMARY OF THE INVENTION

It is a major objective of the present invention to provide a switching power supply circuit structure which has the effect of reducing the inductor magnetizing current and output ripple effectively.

It is another major objective of the present invention to provide another switching power supply circuit structure.

To achieve the above objectives, one switching power supply circuit structure of the present invention includes an input terminal, an output terminal, an energy storage capacitor, a boost circuit, and a second inductor. The input terminal is connected in parallel with an input capacitor. The output terminal has a positive terminal and a negative terminal. The energy storage capacitor is electrically connected between the positive terminal and the ground terminal. The boost circuit comprises a first inductor, a switch component, and a diode. One end of the first inductor, the switch component, and the diode are electrically connected to each other to form a common point. The switch component is electrically connected between the common point and the ground terminal. The second inductor is electrically connected between the negative terminal and the common point, wherein the negative terminal is not connected to the ground terminal.

The other switching power supply circuit structure of the present invention includes an input terminal, an output terminal, a boost circuit, and a second inductor. The input terminal is connected in parallel with the input capacitor. The output terminal has a positive terminal and a negative terminal. The boost circuit comprises a first inductor, a switch component, and a diode. One end of the first inductor, the switch component, and the diode are electrically connected to each other to form a common point. The switch component is electrically connected between the common point and the ground terminal. One end of the second inductor is electrically connected to the positive terminal, and the other end thereof is electrically connected to the diode and the energy storage capacitor. The other end of the energy storage capacitor is electrically connected to the ground terminal, wherein the negative terminal is connected to the common point.

### BRIEF DESCRIPTION OF THE DRAWINGS

FIG. 1 is a schematic diagram of a switching power supply circuit structure according to a first embodiment of the present invention;

FIGS. 2A-2B are schematic diagrams showing the current path of operating the switching power supply circuit structure according to a first embodiment of the present invention;

FIG. 3 is a schematic diagram of a switching power supply circuit structure according to a second embodiment of the present invention;

FIGS. 4A-4B are schematic diagrams showing the current path of operating the switching power supply circuit structure according to a second embodiment of the present invention;

FIG. 5A is a waveform diagram showing the performance of a buck-boost converter of the prior art; and

FIG. 5B is a waveform diagram showing the performance of the switching power supply circuit structure of the present invention.

### DETAILED DESCRIPTION OF THE PREFERRED EMBODIMENT

Hereafter, the technical content of the present invention will be better understood with reference to preferred embodiments.

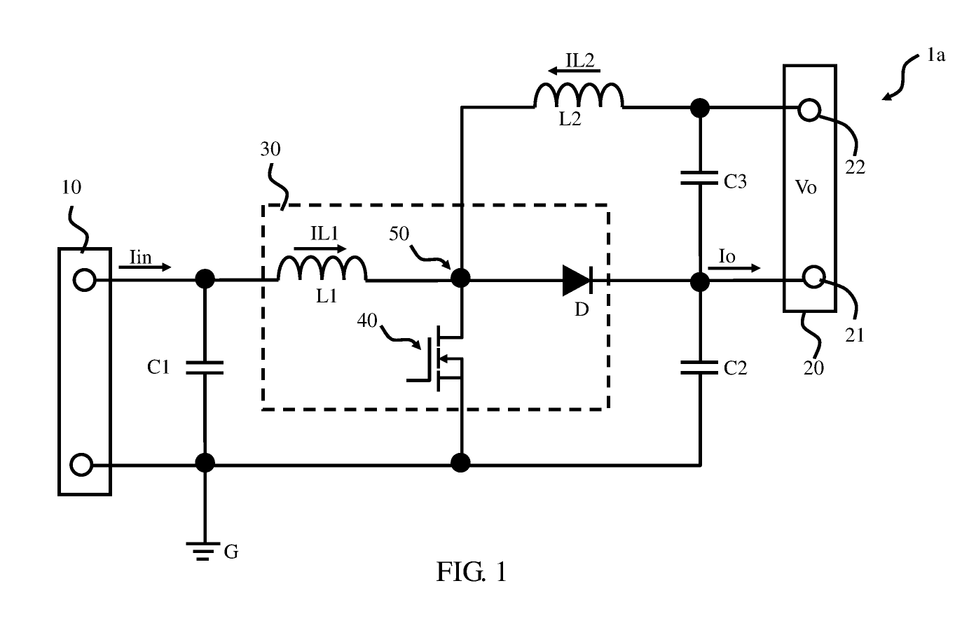

Hereafter, please first refer to FIG. 1, which is a schematic diagram of a switching power supply circuit structure according to a first embodiment of the present invention.

In the first embodiment of the present invention, the switching power supply circuit structure 1a includes an input terminal 10, an output terminal 20, an input capacitor C1, an energy storage capacitor C2, a boost circuit 30, and a second inductor L2. The input terminal 10 is configured to input an original power source having an input current Iin and is connected in parallel with an input capacitor C1 for suppressing a voltage change of the input terminal 10. The output terminal 20 has a positive terminal 21 and a negative terminal 22 for electrically connecting an external load (not shown) for outputting the processed power. The processed power has output current Io and output voltage Vo. The energy storage capacitor C2 is electrically connected between the positive terminal 21 and the ground terminal G. The boost circuit 30 includes a first inductor L1, a switch component 40, and a diode D. The switch component 40 is an active power element. In the first embodiment of the present invention, the switch component 40 is a MOSFET, but the present invention is not limited thereto. Specifically, one end of the first inductor L1, the switch component 40, and the diode D are electrically connected to each other to form a common point 50, and the switch component 40 is electrically connected between the common point 50 and the ground terminal G. The second inductor L2 is electrically connected between the negative terminal 22 and the common point 50, wherein the negative terminal 22 is not connected to the ground terminal G. The first inductor L1 has an inductor magnetizing current IL 1, and the second inductor L2 has an inductor magnetizing current IL2. The switching power supply circuit structure 1a further includes an output capacitor C3, which has a function of stabilizing output voltage.

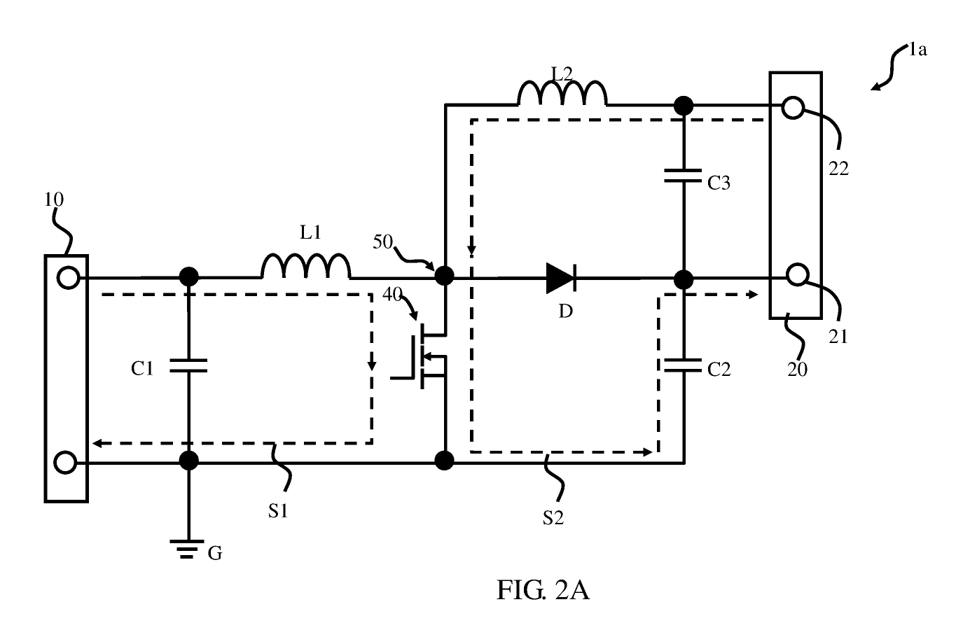

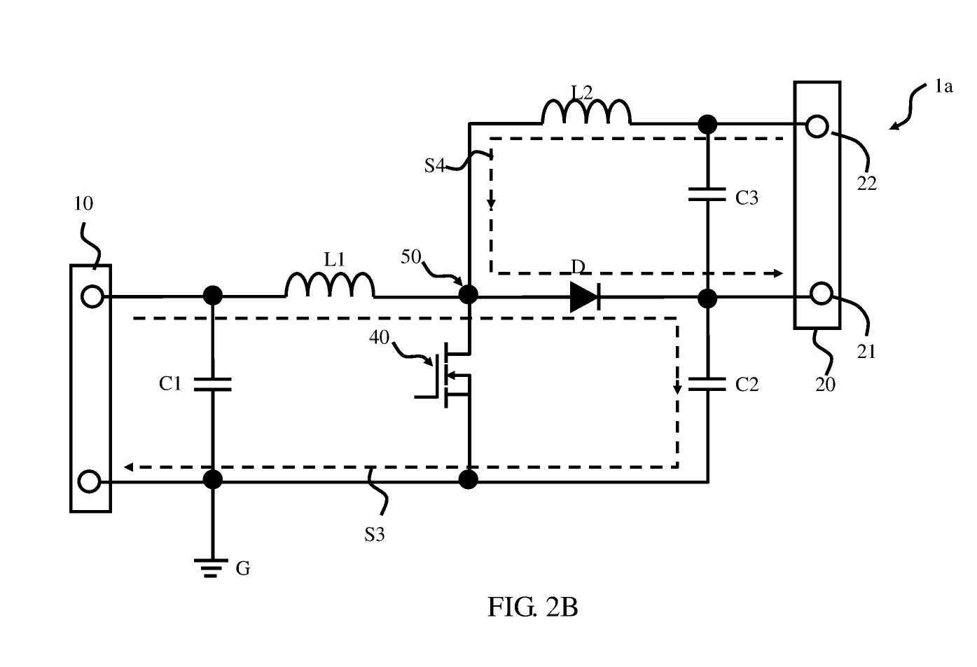

Next, please refer to FIGS. 2A-2B, which are schematic diagrams showing the current path of operating the switching power supply circuit structure according to a first embodiment of the present invention.

In the first embodiment of the present invention, when the switch component 40 is turn on, as shown in FIG. 2A, the diode D will be reverse bias to form turn off, and the first inductor L1, the switch component 40, and the ground terminal G form a first series circuit S1, such that the power of the input terminal 10 flows through the first inductor L1, the switch component 40, and the ground terminal G in sequence to charge the first inductor L1. Meanwhile, through the output terminal 20 and the switch component 40, the energy storage capacitor C2 forms a second series circuit S2 such that the energy of the energy storage capacitor C2 flows through the positive terminal 21, the load and output capacitor C3, the negative terminal 22, the second inductor L2, the switch component 40, and the ground terminal G in sequence to charge the second inductor L2.

When the switch component 40 is turn off, as shown in FIG. 2B, the diode D will be forward biased, and the first inductor L1, the diode D, the energy storage capacitor C2, and the ground terminal G form a third series circuit S3, such that the power of the input terminal 10 flows through the first inductor L1, the diode D, the energy storage capacitor C2, and the ground terminal G to discharge energy of the first inductor L1 to the energy storage capacitor C2. Meanwhile, the second inductor L2, the diode D, and the output terminal 20 form a fourth series circuit S4, such that the second inductor L2 through the diode D discharges energy to the output terminal 20, output capacitor C3 and the load.

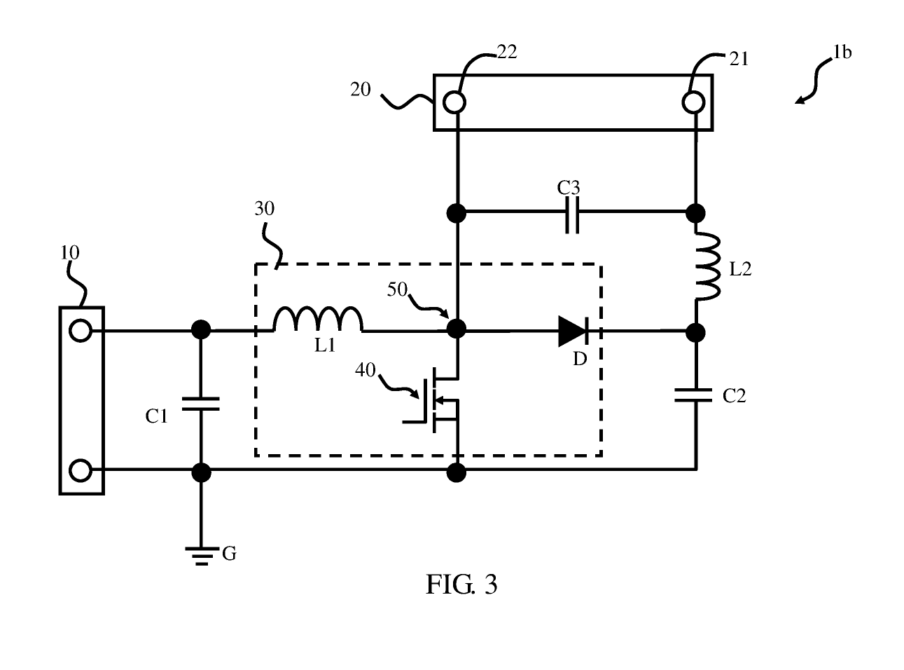

Please refer to FIG. 3, which is a schematic diagram of a switching power supply circuit structure according to a second embodiment of the present invention.

In the second embodiment of the present invention, the switching power supply circuit structure 1b also includes an output terminal 20, an input terminal 10, an input capacitor C1, an energy storage capacitor C2, a boost circuit 30, and a second inductor L2. The output terminal 20 has a positive terminal 21 and a negative terminal 22. The input terminal 10 is connected in parallel with the input capacitor C1. Similarly, the boost circuit 30 includes a first inductor L1, a switch component 40, and a diode D. One end of the first inductor L1, the switch component 40, and the diode D are electrically connected to each other to form a common point 50, and the switch component 40 is electrically connected between the common point 50 and the ground terminal G. However, one end of the second inductor L2 in the second embodiment of the present invention is electrically connected to the positive terminal 21, and the other end of the second inductor L2 is electrically connected to the diode D and the energy storage capacitor C2; the other end of the energy storage capacitor C2 is electrically connected to the ground terminal G, wherein the negative terminal 22 is electrically connected to the common point 50. The switching power supply circuit structure 1b also includes an output capacitor C3, which has a function of stabilizing output voltage.

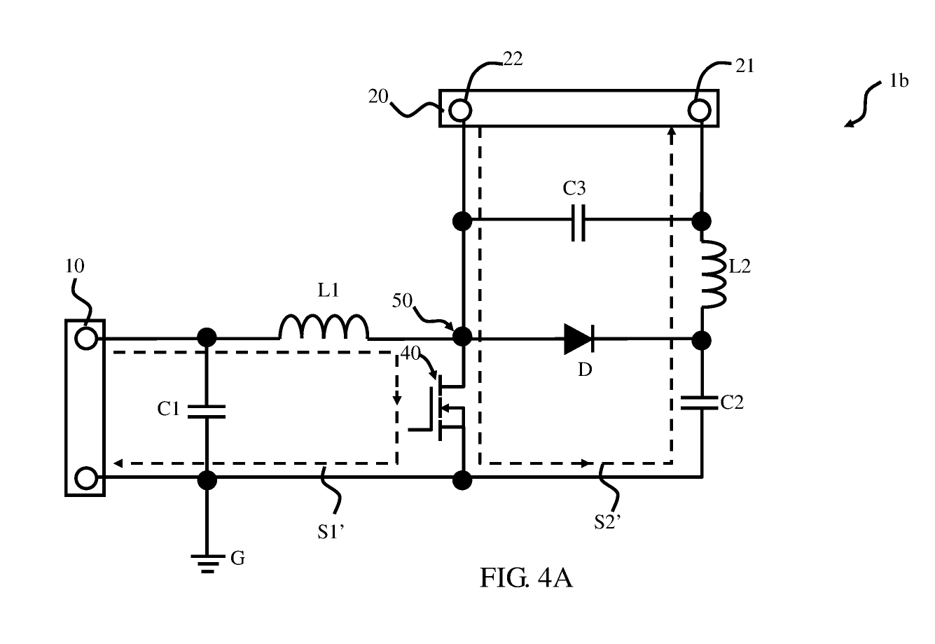

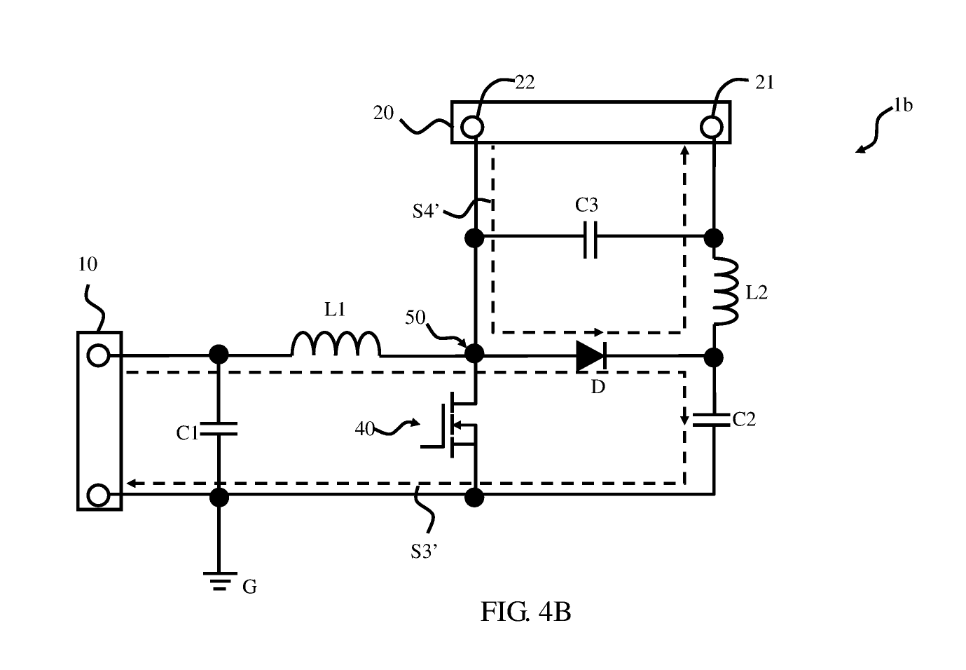

Next, please refer to FIGS. 4A-4B, which are schematic diagrams showing the current path of operating the switching power supply circuit structure according to a second embodiment of the present invention.

In the second embodiment of the present invention, when the switch component 40 is turn on, as shown in FIG. 4A, the diode D will be reverse bias to form turn off, and the first inductor L1, the switch component 40, and the ground terminal G form a first series circuit S1′, such that the power of the input terminal 10 flows through the first inductor L1, the switch component 40, and the ground terminal G to charge the first inductor L1 . Meanwhile, the energy storage capacitor C2 forms a second series circuit S2′ through the output terminal 20 and the switch component 40, such that the energy of the energy storage capacitor C2 flows through the second inductor L2, the load, the output the capacitor C3, the switch component 40, and the ground terminal G in sequence to charge the second inductor L2.

When the switch component 40 is turn off, as shown in FIG. 4B, the diode D will be forward biased, and the first inductor L1, the diode D, the energy storage capacitor C2, and the ground terminal G form a third series circuit S3′. Consequently, the power of the input terminal 10 flows through the first inductor L1, the diode D, the energy storage capacitor C2 and the ground terminal G in sequence, such that the first inductor L1 discharges energy to the energy storage capacitor C2. Meanwhile, the second inductor L2, the diode D, and the output terminal 20 form a fourth series circuit S4′, such that the second inductor L2 through diode D discharges energy to the output terminal 20, output capacitor C3 and the load.

Accordingly, regardless of the switching power supply circuit structure 1a or 1b, when the switch component 40 is in an on or off state, the flow of current through the first inductor L1 is maintained and the magnetizing current of the first inductor L1 can be reduced. Also, when the switch component 40 is in an on or off state, the second inductor L2 and the output capacitor C3 are always connected in series or in parallel with the output terminal 20 to reduce the ripple current of the output terminal 20.

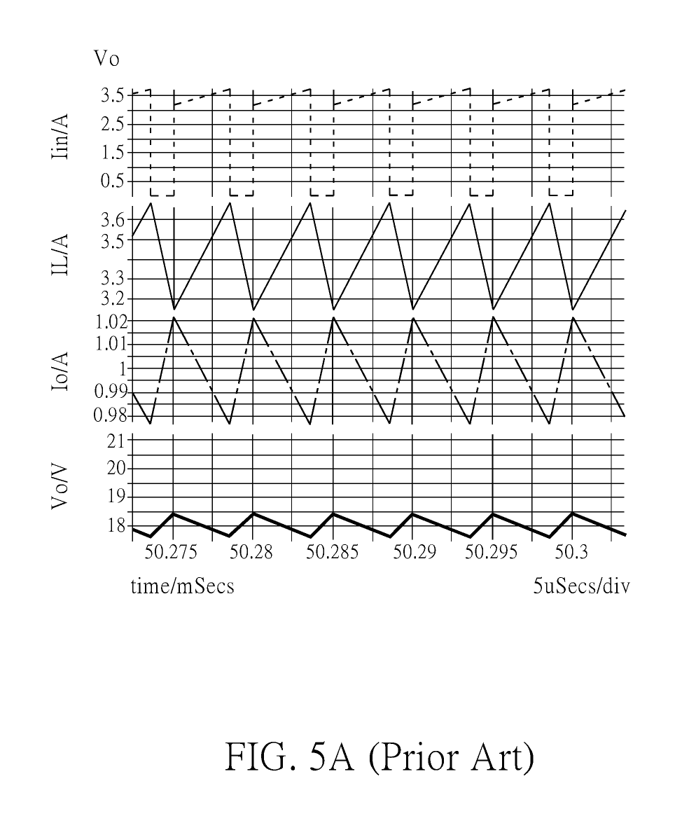

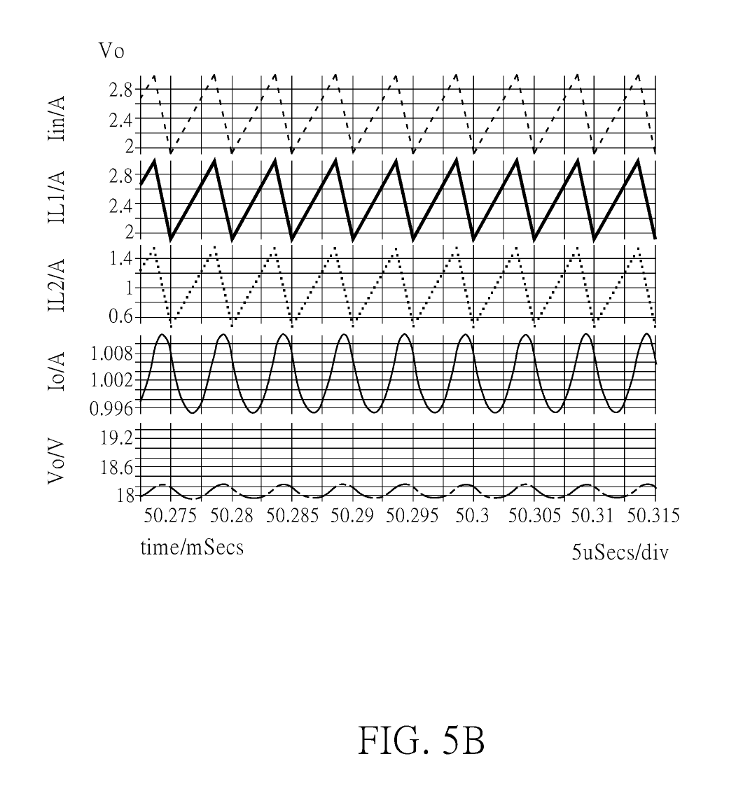

For comparison with the prior art, wherein the input and output are the same, all parts are the same, and the switching frequency is the same, the input current Iin, the inductor magnetizing current IL, ILL IL2, the output current Io, and the output voltage Vo of the switching power supply circuit structure 1a or 1b of the present invention and that of the buck-boost converter of the prior art are shown in FIGS. 5A and 5B. Now please refer to FIGS. 5A-5B, which are waveform diagrams showing the related performances, wherein FIG. 5A is a waveform diagram showing the performance of a buck-boost converter in the prior art and FIG. 5B is a waveform diagram showing the performance of the switching power supply circuit structure of the present invention.

As can be seen from the comparison of the waveform diagrams in FIGS. 5A-5B, the performance of the switching power supply circuit structure 1a or 1b of the present invention is superior to that of the prior art. For example, the input current Iin is not interrupted, and both the inductor magnetizing current IL1 of the first inductor L1 and the inductor magnetizing current IL2 of the second inductor L2 are smaller than the inductor magnetizing current IL of the prior art, thereby reducing the copper loss. The ripple of the output current Io in the present invention is smaller than that of the prior art, and a smaller output capacitor can be used under the same design specification to reduce the size of the output capacitor.

It should be noted that the embodiments of the present invention described above are only illustrative. To avoid unnecessary redundancy, not all of the possible combinations of changes are documented. However, it shall be understood by those skilled in the art that each of the modules or elements described above may not be necessary. For the implementation of the present invention, the present invention may also contain other detailed conventional modules or elements. Each module or component is likely to be omitted or modified depending on need. Other modules or elements may be included or excluded between any two modules without departing from the scope of the invention defined solely by the appended claims.

1. A switching power supply circuit structure, comprising:
an input terminal, which is connected in parallel with an input capacitor;
an output terminal, which has a positive terminal and a negative terminal;
an energy storage capacitor, which is electrically connected between the positive terminal and a ground terminal;
a boost circuit, comprising a first inductor, a switch component, and a diode, wherein one end of the first inductor, the switch component and the diode are electrically connected to each other to form a common point, and the switch component is electrically connected between the common point and the ground terminal; and
a second inductor, which is electrically connected between the negative terminal and the common point, wherein the negative terminal is not connected to the ground terminal;
wherein when the switch component is turn on, the first inductor, the switch component, and the ground terminal form a first series circuit to charge the first inductor, while the energy storage capacitor forms a second series circuit through the output terminal and the switch component to charge the second inductor.

2. (canceled)

3. The switching power supply circuit structure as claimed in claim 1, further comprising an output capacitor which has a function of stabilizing output voltage.

4. The switching power supply circuit structure as claimed in claim 1, wherein when the switch component is turn off, the first inductor, the diode, the energy storage capacitor, and the ground terminal form a third series circuit, and the first inductor discharges energy to the energy storage capacitor, while the second inductor and the diode forms a fourth series circuit with the output terminal such that the second inductor discharges energy to the output terminal.

5. The switching power supply circuit structure as claimed in claim 1, wherein when the switch component is in an on or off state, the flow of current through the first inductor is maintained to reduce the magnetizing current of the first inductor.

6. The switching power supply circuit structure as claimed in claim 1, wherein when the switch component is in an on or off state, the second inductor and the output capacitor are always connected in series or in parallel with the output terminal to reduce the ripple current of the output terminal.

7. A switching power supply circuit structure, comprising:
an input terminal, which is connected in parallel with an input capacitor;
an output terminal, which has a positive terminal and a negative terminal;
a boost circuit, comprising a first inductor, a switch component, and a diode, wherein one end of the first inductor, the switch component, and the diode are electrically connected to each other to form a common point, and the switch component is electrically connected between the common point and a ground terminal; and
a second inductor, one end of the second inductor is electrically connected to the positive terminal and the other end of the second inductor is electrically connected to the diode and an energy storage capacitor, and the other end of the energy storage capacitor is electrically connected to the ground terminal, wherein the negative terminal is electrically connected to the common point.

8. The switching power supply circuit structure as claimed in claim 7, wherein when the switch component is turn on, the first inductor, the switch component, and the ground terminal form a first series circuit to charge the first inductor, while the energy storage capacitor forms a second series circuit through the output terminal and the switch component to charge the second inductor.

9. The switching power supply circuit structure as claimed in claim 7, further comprising an output capacitor which has a function of stabilizing output voltage.

10. The switching power supply circuit structure as claimed in claim 7, wherein when the switch component is turn off, the first inductor, the diode, the energy storage capacitor, and the ground terminal form a third series circuit such that the first inductor discharges energy to the energy storage capacitor, while the second inductor, the diode, and the output terminal form a fourth series circuit such that the second inductor discharges energy to the output terminal.

11. The switching power supply circuit structure as claimed in claim 7, wherein when the switch component is in an on or off state, the flow of current through the first inductor is maintained to reduce the magnetizing current of the first inductor.

12. The switching power supply circuit structure as claimed in claim 7, wherein when the switch component is in an on or off state, the second inductor and the output capacitor are always connected in series or in parallel with the output terminal to reduce the ripple current of the output terminal.
